(19) United States
(12) Patent Application Publication
(10) Pub. No.: US 2011/0082740 A1
(43) Pub. Date: Apr. 7, 2011

(54) Pay Per Stay

(76) Inventors: Scott Rupert Colwell, Waterloo (CA); Rosslyn Susan Merswolke, Waterloo (CA)

(21) Appl. No.: 12/493,221

(22) Filed: Oct. 5, 2009

(51) Int. Cl. G06Q 30/00

(52) U.S. Cl. 705/14.39

(57) ABSTRACT

Pay Per Stay is a web site that directs traffic to other websites, for a designated period of time. Users are rewarded for spending time at a directed site, with either a coupon, a prize, monetary or other reward.

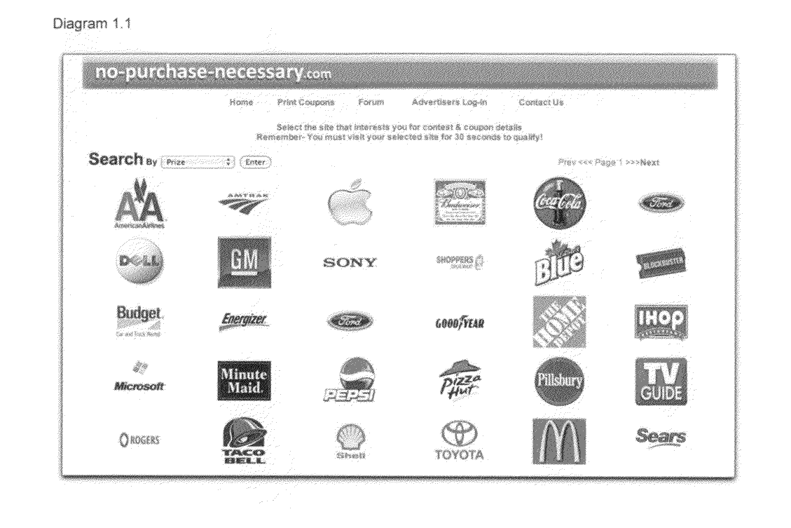

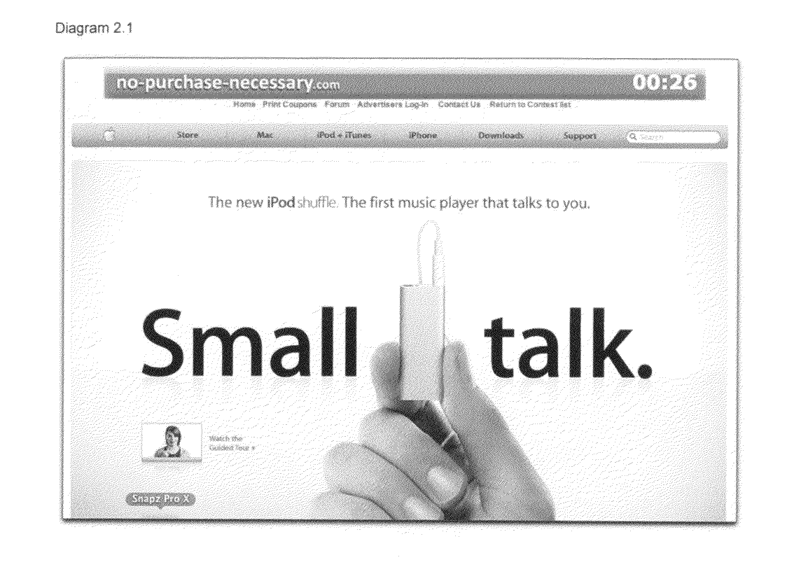

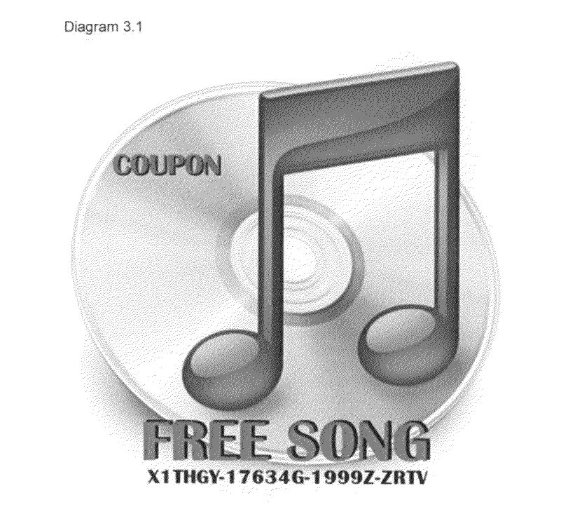

Pay Per Stay is a web site that directs traffic to other websites, for a designated period of time. Users are rewarded for spending time at a directed site, with either a coupon, a prize, monetary or other reward. A user logs into our web site (Pay Per Stay) and is then given a list of different websites (Diagram 1.1) they can visit that will reward them for time spent visiting these other websites. When that user makes a selection, they are redirected to their choice (Diagram 2.1) site that is embedded (inside or part of) in the Pay Per Stay site. A timer (Diagram 2.1 top right) begins a countdown (i.e. 26 sec) while the user browses where they choose, confined to the chosen site. When the timer reaches zero the user is automatically rewarded with said reward (coupon, prize, etc.) The user can choose to continue browsing where they are, or make another choice from the Pay Per Stay web site that will reward them again for more time spent. All rewards are credited to each users account (Diagram 3.1), and include printable bar codes that are redeemed by the Advertiser, whose site had been visited (by the user) for a specific period of time. The Advertiser is provided with a complete list of visitors, time spent by visitor, and viewing habits of each visitor (pages visited) that has been directed to their web site. The Advertiser or representative of the advertiser (ie. Ad agency) pays Pay Per Stay for the traffic directed to their site.

### BRIEF DESCRIPTIONS OF DIAGRAMS

(Description of diagram 1.1—after a person logs in, this is a diagram of what their computer screen might look like. They are given a list of different companies via the company's logo. The visitor can then select a logo by clicking on it, and they are then redirected to that company's site.) The Pay Per Stay site is a frames based web site, therefore the visitor surfs through their selected web sites but remain inside Pay Per Stay's URL or Uniform Resource Locator. This makes it possible to track the amount of time they spend visiting their selected company, who because of having them directed to their site, rewards them with a coupon or special offer.

(Description of diagram 2.1—after a person makes a selection from diagram 1.1, this is a diagram of what their computer screen might look like. They are redirected to a company's site, in this example apple.com. A timer (top right) begins to count down. When the timer reaches zero, the visitor is rewarded for their time spent with a coupon from the company they selected and spent time in their site.)

(Description of diagram 3.1—This is an example of a coupon that would show up on a person's computer screen after they spent a required amount of time in a company's web site. (This example from apple.com) a person could then print their coupon for use later.)

1. The idea of rewarding a user for spending a specific amount of time viewing a website is new and never been used to this point. There are many different business models where advertisers pay to have traffic directed to their website (ie. Pay per Click), but there is no guarantee or promise that the visitor will stay in the site for a pre-determined period of time. For example, if visitor1 goes to website1, and spends a pre-determined period of time (ie. 30 seconds), they will receive coupon1. Therefore, the patent is that people are rewarded for spending a specific period time visiting a website. The reward could be in the form of coupons, prizes, monetary etc. Regardless of how another competitor might duplicate this process (being rewarded for spending specific time in a site), this would be an infringement on this patent.
